(19) United States
(12) Patent Application Publication
(10) Pub. No.: US 2015/0108688 A1
(43) Pub. Date: Apr. 23, 2015

(54) RESIN DISPENSER FOR NANO-IMPRINT

(71) Applicants: Samsung Electronics Co., Ltd., Suwon-si (KR); Samsung Display Co., Ltd., Yongin-City (KR)

(72) Inventors: Bong-su SHIN, Seoul (KR); Dong-ouk KIM, Pyeongtaek-si (KR); Joon-young PARK, Suwon-si (KR); Sung-hoon LEE, Seoul (KR); Jae-seung CHUNG, Seoul (KR); Suk-gyu HAHM, Gyeongju-si (KR); Dae-young LEE, Seoul (KR); Gug-rae JO, Asan-si (KR)

(21) Appl. No.: 14/307,753

(22) Filed: Jun. 18, 2014

(30) Foreign Application Priority Data
Oct. 22, 2013 (KR) 10-2013-0126112

(51) Int. Cl. B28B 7/30; B41J 2/14

(52) U.S. Cl. CPC B05C 5/0291; B29C 59/002; B05C 5/0254
USPC 264/313; 347/51; 422/500

(57) ABSTRACT

A resin dispenser for nano-imprinting includes a housing including a lower chamber in which a resin is filled, a slit defined in a lower part of the lower chamber and through which the resin is discharged, and an upper chamber in which a pressure-applying fluid is filled, and a membrane separating the lower and upper chambers from each other, and of which an edge is fixed on a middle part of the housing, where the fluid is configured to apply the pressure to the membrane and protrude the membrane toward the slit of the lower chamber.

### CROSS-REFERENCE TO RELATED APPLICATIONS

This application claims the benefit of Korean Patent Application No. 10-2013-0126112, filed on Oct. 22, 2013, and all the benefits accruing therefrom under 35 U.S.C. §119, the disclosure of which is incorporated herein in its entirety by reference.

### BACKGROUND

1. Field

Embodiments of the invention relate to resin dispensers for nano-imprint.

2. Description of the Related Art

Generally, a nano-imprint process is referred to as a process of transferring a pattern on a transfer substrate by using a stamp on which the pattern having a desired shape is formed.

In order to have a nano-imprint, a manufacture of a stamp is prepared in advance. After coating a resin on a prepared master substrate, a pattern is transferred on the stamp. Generally, the resin used in manufacturing the stamp has a high viscosity. However, to efficiently manufacture the stamp, it is important to determine an appropriate amount of resin in consideration of a nano-imprint structure of the master substrate and a transfer area of the pattern on the master substrate. Uniformity of the nano-imprinting pattern is an important factor for determining a quality of the nano pattern of a final product.

### SUMMARY

In a case of a general nano-imprinting, since a time from a resin coating to applying a pressure to a transfer substrate is very short, a resin coating by an inkjet method is generally adopted. However, in a case of a nano-imprinting by using a roll-to-roll method or a roll-to-plate method, a time from a resin coating to a completion of roll pressing onto a transfer substrate is relatively long, and thus, an evaporation of resin becomes a problem, and accordingly, the use of a resin dispensing method using inkjet may be limited. Also, the evaporation of resin may cause a thickness difference of residue resin between nano-imprinting patterns.

Provided are nano-imprinting dispensers that form a uniform nano-pattern on a transfer substrate by reducing a resin dispensing time in a nano-imprinting that uses a roll.

Additional embodiments will be set forth in part in the description which follows and, in part, will be apparent from the description, or may be learned by practice of the presented embodiments.

According to an embodiment of the invention, a resin dispenser for nano-imprinting includes a housing including a lower chamber in which a resin is filled, a slit defined in a lower part of the lower chamber and through which the resin is discharged, and an upper chamber in which a pressure-applying fluid is filled; and a membrane separating the lower and upper chambers from each other, and of which an edge is fixed on a middle part of the housing, wherein the fluid is configured to apply the pressure to the membrane and protrude the membrane toward the slit of the lower chamber.

In an embodiment, the membrane may include one of PET, polycarbonate, and polytetrafluoroethylene (“PTFE”) such as Teflon®.

In an embodiment, a width W of the slit satisfies the following Equation.

$$W \leq √ ( \frac{γ}{ρ g} )$$

where γ is a surface tension of the resin, ρ is a density of the resin, and g is an acceleration of gravity. In an embodiment, the width W may be measured in terms of millimeters (mm).

In an embodiment, the resin dispenser may further include a resin supply pump that is connected to the lower chamber to supply a resin to the lower chamber.

In an embodiment, the resin dispenser may further include a fluid supply pump that is connected to the upper chamber to supply a fluid to the upper chamber.

In an embodiment, the fluid may be air or water.

In an embodiment, the housing may include an upper housing and a lower housing, and an edge of the membrane may be fixed between a flange of the upper housing and a flange of the lower housing.

According to another embodiment of the invention, a resin dispenser for nano-imprinting includes a housing having a slit on a lower part thereof, a shape-memory alloy film that is fixed on an upper surface of the housing, and a power source that supplies power to the shape-memory alloy film.

In an embodiment, the shape-memory alloy film may include a nickel-titanium alloy.

In an embodiment, the resin dispenser may further include an insulating sheet disposed between the upper surface of the housing and the shape-memory alloy film.

### BRIEF DESCRIPTION OF THE DRAWINGS

These and/or other embodiments will become apparent and more readily appreciated from the following description of the embodiments, taken in conjunction with the accompanying drawings, in which:

FIG. 1 is a schematic cross-sectional view of an imprinting apparatus to which a resin dispenser for nano-imprinting according to embodiments of the invention;

FIG. 2 is a schematic perspective view of a structure of a resin dispenser for nano-imprinting according to embodiments of the invention;

FIG. 3 is a cross-sectional view taken along line III-III′ of FIG. 2;

FIG. 4 is a cross-sectional view for explaining an operation of a resin dispenser for nano-imprinting according to embodiments of the invention; and

FIG. 5 is a schematic cross-sectional view of a structure of a resin dispenser for nano-imprinting according to embodiments of the invention.

### DETAILED DESCRIPTION

Reference will now be made in detail to embodiments, examples of which are illustrated in the accompanying drawings. In the drawings, thicknesses may be exaggerated for clarity of layers and regions. The embodiments of the invention are capable of various modifications and may be embodied in many different forms. When a layer, a film, a region, or a panel is referred to as being “on” another element, it can be directly on the other layer or substrate, or intervening layers may also be present. Like numerals refer to like elements throughout the description of the figures. Like reference numerals are used to indicate elements that are substantially identical to each other, and thus, the detailed description thereof will be omitted. As used herein “connected” may mean in physical, electrical and/or fluid connection.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

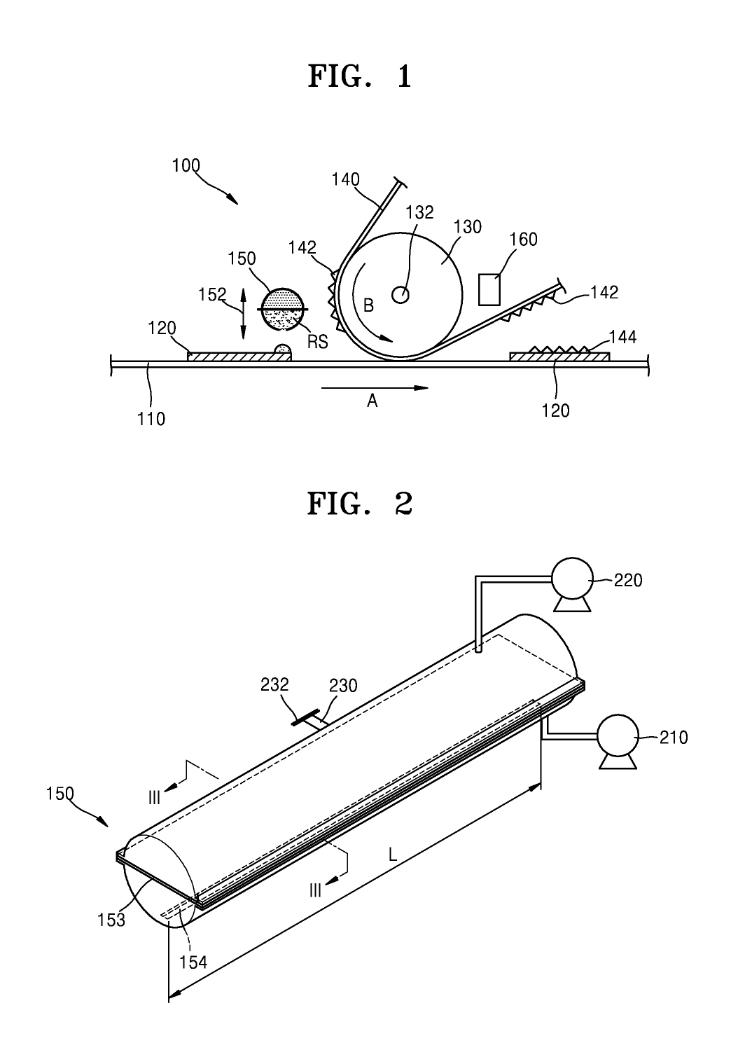

FIG. 1 is a schematic cross-sectional view of an imprinting apparatus 100 to which a resin dispenser 150 for nano-imprinting according to embodiments of the invention.

Referring to FIG. 1, a transfer substrate 120 is disposed on a conveyor belt 110 that moves in a first direction indicated by an arrow A. A first roll 130 is disposed on the transfer substrate 120 upstream of the first direction of the conveyor belt 110. The first roll 130 is rotatably fixed on a location. A stamp belt 140 is rotatably wound on an outer circumference of the first roll 130, and a first pattern 142 is provided on the stamp belt 140. In FIG. 1, the stamp belt 140 is wound along the outer circumference of the first roll 130, but the invention is not limited thereto. In an embodiment, the stamp belt 140 may be supplied separately from the conveyor belt 110, and may be disposed between the conveyor belt 110 and the first roll 130. In an embodiment, the stamp belt 140 may include polyethylene terephthalate (“PET”), for example.

The resin dispenser 150 is installed on the first roll 130 downstream of the first direction of the conveyor belt 110. The resin dispenser 150 is separately disposed upwards from the conveyor belt 110. The resin dispenser 150 is disposed between the transfer substrate 120 and the first roll 130. When a front edge of the transfer substrate 120 is moved to below the resin dispenser 150 due to the moving of the conveyor belt 110, the resin dispenser 150 is lowered close to the conveyor belt 110 by a vertical moving unit 152.

Next, a resin RS in the resin dispenser 150 is discharged on the transfer substrate 120. In an embodiment, the resin RS may be an imprinting resin, for example, an ultraviolet (“UV”) light curing acrylic-based resin.

Afterwards, the first roll 130 rotates in a direction indicated by an arrow B as the conveyor belt 110 moving in the first direction A. Due to the rotation of the first roll 130, the resin RS on the transfer substrate 120 is uniformly distributed to be thin on the transfer substrate 120. The stamp belt 140 rotates as the rotation of the first roll 130, and thus, the first pattern 142 is transferred onto the resin RS on the transfer substrate 120. Consequentially, a second pattern 144 is disposed on the transfer substrate 120. Next, the resin dispenser 150 is separated from the conveyor belt 110 by the vertical moving unit 152.

In FIG. 1, the first roll 130 rotates on a fixed location, but the invention is not limited thereto. In another embodiment, a rotation axis 132 of the first roll 130 may be moved in a direction opposite to the first direction A. Also, the first roll 130 may be straightly moved in a direction opposite to the first direction A while driving the conveyor belt 110 in the first direction A.

Next, the second pattern 144 on the transfer substrate 120 is cured by a UV light irradiation device 160, for example, a UV light lamp that is disposed on an upstream of the first roll 130 above the conveyor belt 110. Next, when the stamp belt 140 is separated from the transfer substrate 120, the patterning process is completed.

The resin discharged from the resin dispenser 150 may have high viscosity. After the resin discharged from the resin dispenser 150 contacts the conveyor belt 110 by moving the resin dispenser 150 towards the transfer substrate 120, when the supply of the resin is completed, the resin dispenser 150 may be moved upwards from the transfer substrate 120. The imprinting apparatus 100 may include the vertical moving unit 152 to move the resin dispenser 150.

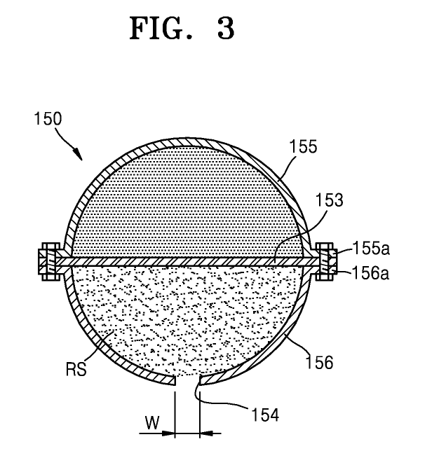

FIG. 2 is a schematic perspective view of a structure of a resin dispenser 150 for nano-imprinting according to embodiments of the invention. FIG. 3 is a cross-sectional view taken along line III-III+ of FIG. 2.

Referring to FIGS. 2 and 3, a housing of the resin dispenser 150 may have a hollowed cylindrical shape, for example. The housing includes an upper housing 155 and a lower housing 156. In an embodiment, the upper and lower housings 155 and 156 may include a hard material, for example, plastic or stainless steel, for example.

A membrane 153 may be disposed between the upper and lower housings 155 and 156. The housing is divided into an upper chamber and a lower chamber by the membrane 153. The upper chamber may be filled with a fluid, for example, air or water, for example. The lower chamber may be filled with a resin, for example, UV light curing resin.

A slit 154 is defined at a lower part of the lower housing 156 in a length direction of the housing. A resin is discharged through the slit 154.

In an embodiment, the membrane 153 may be an elastic material film. The membrane 153 may include at least one of PET, polycarbonate, or polytetrafluoroethylene (“PTFE”) such as Teflon®. An edge of the membrane 153 is fixed by being disposed between a flange 155a of the upper housing 155 and a flange 156a of the lower housing 156. In an embodiment, the flanges 155a and 156a and the edge of the membrane 153 may be tightened by fixing members such as a bolt and a nut as shown in FIG. 3.

A fluid pump 220 may be connected to the upper housing 155, and a resin supply pump 210 may be connected to the lower housing 156. A discharge outlet 230 for discharging the fluid in the upper chamber to the outside is connected to the upper housing 155. A shutter 232 for controlling the discharge of the fluid to the outside is connected to an edge of the discharge outlet 230.

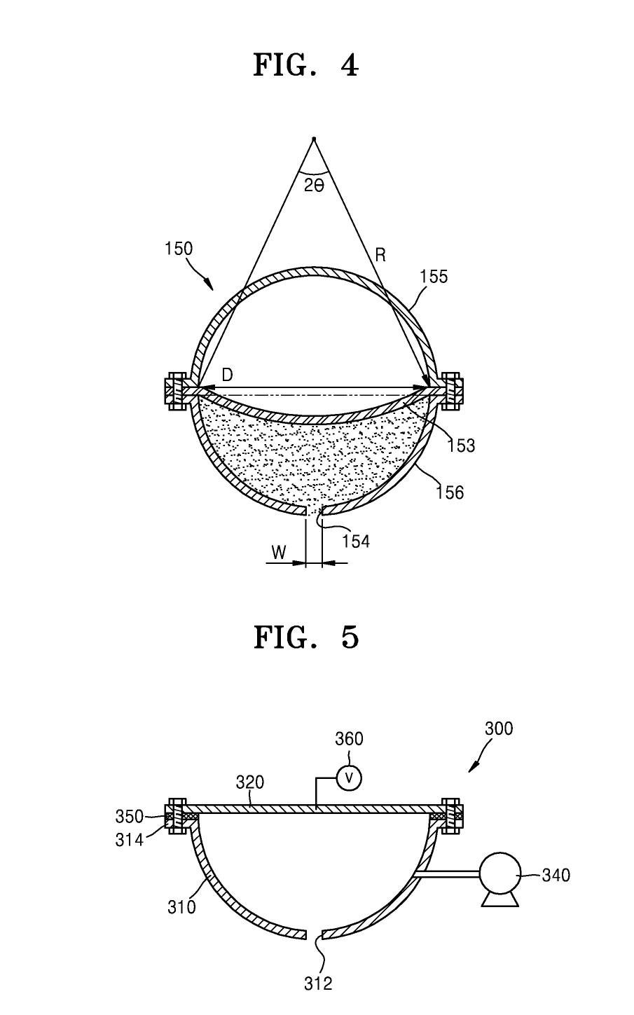

FIG. 4 is a cross-sectional view for explaining an operation of a resin dispenser 150 for nano-imprinting according to embodiments of the invention. Referring to FIG. 4, the lower housing 156 of the resin dispenser 150 may be filled with a UV light curing resin. In an exemplary embodiment, the resin may have a density in a range from about 1.0 gram per cubic centimeter (g/cm³) to about 1.5 g/cm³, and a surface tension in a range from about 30×10⁻³ newton per meter (N/m) to about 50×10⁻³ N/m. When a fluid is supplied to the upper chamber by using the fluid pump 220, the membrane 153 protrudes towards the slit 154 as depicted in FIG. 4. In FIG. 4, a radius of curvature R and an angle of circumference 28 of a circular arc that is provided by the membrane 153 are depicted.

In the case when a width of the membrane 153 is D, a ½ angle of circumference θ may be calculated by the following Equation.

$$θ = {sin}^{- 1} ( \frac{D Δ p}{2 γ} )$$

where, Δp is a pressure of the upper chamber, and γ is a surface tension of the resin.

A supply volume V of the resin due to the deformation of the membrane 153 is calculated from the following Equation.

$$V = L ( \frac{{R}^{3} θ}{2} - \frac{γ R}{Δ p} sin 2 θ )$$

where, L is a length of the slit 154 of the resin dispenser 150.

A width W of the slit 154 may be calculated from the following Equation.

$$W \leq √ ( \frac{γ}{ρ g} )$$

where, γ is the surface tension of the resin, ρ is a density of the resin, and g is an acceleration of gravity.

Accordingly, the width W of the slit 154 is designed such that the resin is not flow by only the gravitational force. In an embodiment, the width W of the slit 154 may be calculated in a range from about 1.7 millimeters (mm) to about 2.2 mm according to the resin.

Hereinafter, an operation of the imprinting apparatus 100 will be described with reference to FIGS. 1 through 4.

The transfer substrate 120, the resin dispenser 150, the stamp belt 140, the first roll 130, and the UV light irradiation device 160 are sequentially disposed in the moving direction A of the conveyor belt 110. The stamp belt 140 is pressed between the conveyor belt 110 and the first roll 130, and the conveyor belt 110 and the stamp belt 140 are synchronously moved according to the rotation of the first roll 130.

When the transfer substrate 120 is moved below the slit 154 of the resin dispenser 150, the fluid pump 220 supplies the fluid to the upper chamber to apply a predetermined pressure to the upper chamber. Accordingly, the membrane 153 is convexly deformed downwards. Thus, a predetermined amount of resin is discharged through the slit 154. That is, the slit 154 discharges the resin on the transfer substrate 120 in a width direction of the conveyor belt 110 which corresponds to the lengthy direction of the slit 154.

Next, when the conveyor belt 110 moves in the first direction A, the first roll 130 rotates in the second direction B due to the friction between the first roll 130 and the conveyor belt 110, and the stamp belt 140 on the first roll 130 rotates by being interposed between the first roll 130 and the conveyor belt 110. At this point, the resin on the transfer substrate 120 is thinly spread by the first roll 130, and the first pattern 142 is transferred on the resin. As a result, the first pattern 142 on the stamp belt 140 is transferred to the resin, that is, the second pattern 144 of the resin is provided. Next, the second pattern 144 is cured by the UV light irradiation device 160. The formation of a pattern on the transfer substrate 120 is completed by separating the stamp belt 140 from the second pattern 144.

After the resin is discharged from the resin dispenser 150, the location of the membrane 153 is restored by discharging the fluid from the upper chamber by stopping the fluid pump 220 and opening the shutter 232. Next, the shutter 232 is closed. Next, the lower chamber is filled with the resin by using the resin supply pump 210.

When the resin dispenser 150 described above is used, since the resin is linearly discharged on the transfer substrate 120 at a short time, although the resin is a volatile resin, a resin supply time is substantially short and a surface area of the coated resin is reduced when compared to the resin that is discharged in droplets as a dot shape. Accordingly, the evaporation of the resin is reduced, thereby providing a uniform pattern on the transfer substrate 120.

Also, an amount of resin that is supplied on the transfer substrate 120 may be readily controlled when the width W of the slit 154 and the supply amount of fluid are controlled.

FIG. 5 is a schematic cross-sectional view of a structure of a resin dispenser 300 for nano-imprinting according to embodiments of the invention.

Referring to FIG. 5, the resin dispenser 300 includes a housing 310 and a shape-memory alloy film 320 that covers an upper surface of the housing 310. The shape-memory alloy film 320 is installed such that edges thereof are fixed on the upper surface of the housing 310. A slit 312 is defined in a lower side of the housing 310. A chamber in the housing 310 is filled with a resin. A resin supply pump 340 is connected to the housing 310.

In an exemplary embodiment, the housing 310 may include a hard material, for example, plastic or stainless steel.

A flange 314 may be disposed on the upper surface of the housing 310, and an insulating sheet 350 may be disposed on the flange 314 to cover the flange 314. The shape-memory alloy film 320 is disposed on the insulating sheet 350. The insulating sheet 350 prevents electrical connection between the housing 310 and the shape-memory alloy film 320 when the housing 310 includes a conductive material, and also, may prevent the resin from leaking.

In an exemplary embodiment, the shape-memory alloy film 320 may include a nickel titanium (NiTi) alloy. A power source 360 may be connected to both edges in a length direction of the shape-memory alloy film 320. When power is supplied to both edges of the shape-memory alloy film 320 from the power source 360, the shape-memory alloy film 320 convexly protrudes towards the slit 312 from an original shape, and accordingly, the resin in the chamber is ejected to the outside through the slit 312.

When the power supplied to the shape-memory alloy film 320 is cut-off, the shape-memory alloy film 320 is restored.

The resin dispenser 300 that uses the shape-memory alloy film 320 can coat a resin on a transfer substrate 120 (refers to FIG. 1) in a short time, and thus, the evaporation of resin is reduced in a stamp transfer using a roll. Accordingly, a uniform pattern may be provided on the transfer substrate.

Also, the structure of the resin dispenser 300 is simplified.

As described above, a resin dispenser for nano-imprinting according to embodiments of the invention discharges a resin onto a transfer substrate in a line shape, although the resin is a volatile resin, a resin supply time is reduced and a surface area of the coated resin is reduced when compared to the resin that is discharged in droplets as a dot shape. Accordingly, the evaporation of the resin is reduced, thereby providing a uniform pattern on the transfer substrate.

It should be understood that the embodiments described therein should be considered in a descriptive sense only and not for purposes of limitation. Descriptions of features within each embodiment should typically be considered as available for other similar features in other embodiments.

While one or more embodiments of the invention have been described with reference to the figures, it will be understood by those of ordinary skill in the art that various changes in form and details may be made therein without departing from the spirit and scope of the invention as defined by the following claims.

What is claimed is:

1. A resin dispenser for nano-imprinting, comprising:
a housing comprising:
a lower chamber in which a resin is filled;
a slit defined in a lower part of the lower chamber and through which the resin is discharged; and
an upper chamber in which a pressure-applying fluid is filled; and
a membrane separating the lower and upper chambers from each other, and of which an edge is fixed on a middle part of the housing,
wherein the fluid is configured to apply the pressure to the membrane and protrude the membrane toward the slit of the lower chamber.

2. The resin dispenser of claim 1, wherein the membrane includes at least one of polyethylene terephthalate, polycarbonate, and polytetrafluoroethylene.

3. The resin dispenser of claim 1, wherein a width W of the slit satisfies the following Equation.
$$W \leq √ ( \frac{γ}{ρ g} )$$
where γ is a surface tension of the resin, ρ is a density of the resin, and g is an acceleration of gravity.

4. The resin dispenser of claim 1, further comprising a resin supply pump which is connected to the lower chamber and supplies the resin to the lower chamber.

5. The resin dispenser of claim 1, further comprising a fluid pump which is connected to the upper chamber and supplies the fluid to the upper chamber.

6. The resin dispenser of claim 5, wherein the fluid is air or water.

7. The resin dispenser of claim 1, wherein the housing comprises an upper housing and a lower housing, and the edge of the membrane is fixed between a flange of the upper housing and a flange of the lower housing.

8. A resin dispenser for nano-imprinting, comprising:
a housing in which a slit is defined in a lower part of the housing;
a shape-memory alloy film which is fixed on an upper surface of the housing; and
a power source which supplies power to the shape-memory alloy film.

9. The resin dispenser of claim 8, wherein the shape-memory alloy film includes a nickel-titanium alloy.

10. The resin dispenser of claim 8, wherein a width W of the slit satisfies the following Equation.
$$W \leq √ ( \frac{γ}{ρ g} )$$
where γ is a surface tension of the resin, ρ is a density of the resin, and g is an acceleration of gravity.

11. The resin dispenser of claim 8, further comprising a resin supply pump which is connected to the housing.

12. The resin dispenser of claim 8, further comprising an insulating sheet disposed between the upper surface of the housing and the shape-memory alloy film.
